(19) United States
(12) Patent Application Publication
(10) Pub. No.: US 2019/0311830 A1
(43) Pub. Date: Oct. 10, 2019

(54) COIL COMPONENT AND METHOD OF MANUFACTURING THE SAME

(71) Applicant: SAMSUNG ELECTRO-MECHANICS CO., LTD., Suwon-si (KR)

(72) Inventor: Mi Geum KIM, Suwon-si (KR)

(21) Appl. No.: 16/172,530

(22) Filed: Oct. 26, 2018

(30) Foreign Application Priority Data
Apr. 6, 2018 (KR) 10-2018-0040371

(51) Int. Cl. H01F 17/00; H01F 41/04; H01F 27/29; H01F 27/255; H01F 17/04; H01F 27/28

(52) U.S. Cl. CPC H01F 17/0013; H01F 41/043; H01F 41/046; H01F 27/292; H01F 2027/2809; H01F 17/04; H01F 27/2804; H01F 2017/048; H01F 27/255

(57) ABSTRACT

A coil component includes a magnetic body including a magnetic material; and a coil part disposed in the magnetic body. The coil part may include a first plating layer and a second plating layer disposed on a surface of the first plating layer, and a surface roughness of the second plating layer may be within a range from 1 nm to 600 nm.

### CROSS-REFERENCE TO RELATED APPLICATION(S)

This application claims the benefit of priority to Korean Patent Application No. 10-2018-0040371 filed on Apr. 6, 2018 in the Korean Intellectual Property Office, the disclosure of which is incorporated herein by reference in its entirety.

### BACKGROUND

### 1. Field

The present disclosure relates to a coil component and a method of manufacturing the same.

### 2. Description of Related Art

An inductor, which is a type of coil electronic component, is a representative passive element removing noise together with a resistor and a capacitor. A thin film type inductor may be manufactured by forming coil conductors by plating, hardening a magnetic powder-resin composite in which magnetic powders and a resin are mixed with each other to manufacture a magnetic body, and forming external electrodes on outer surfaces of the magnetic body.

Recently, in accordance with trends toward increased complexation, multifunctionalization, and slimness of a product, attempts to miniaturize thin film type inductors have been continuously conducted. However, in a case in which the thin film type inductor is manufactured to have a small size, since a volume of the magnetic body, which implements characteristics of the components, is reduced, and there is a limit to increase a line width or a thickness of a coil, the characteristics of the components are deteriorated. Accordingly, in the art, a solution capable of solving the problem of the characteristic deterioration is required, even in such a miniaturization trend.

### SUMMARY

An aspect of the present disclosure may provide a coil component exhibiting low direct current (DC) resistance Rdc by increasing cross-sectional areas of coil parts, and a method of manufacturing the same.

According to an aspect of the present disclosure, a coil component may include a magnetic body including a magnetic material; and a coil part disposed in the magnetic body, wherein the coil part includes a first plating layer and a second plating layer disposed on a surface of the first plating layer, and surface roughness of the second plating layer is 1 nm to 600 nm.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic perspective view of a coil component according to an exemplary embodiment in the present disclosure;

FIG. 2 is a cross-sectional view taken along a line I-I′ of the coil component according to the exemplary embodiment of FIG. 1;

FIG. 3 illustrates an example of an enlarged view of a portion ‘A’ of the coil component according to the exemplary embodiment of FIG. 2;

FIGS. 4A through 4d are views illustrating processes of manufacturing the coil component according to the exemplary embodiment of FIG. 3;

FIG. 5 illustrates another example of the enlarged view of the portion ‘A’ of the coil component according to the exemplary embodiment of FIG. 2;

FIGS. 6A through 6F are views illustrating processes of manufacturing the coil component according to the exemplary embodiment of FIG. 5; and

FIGS. 7 and 8 are perspective views illustrating figures in which the coil component according to an exemplary embodiment in the present disclosure is mounted on a printed circuit board.

### DETAILED DESCRIPTION

Hereinafter, exemplary embodiments of the present disclosure will now be described in detail with reference to the accompanying drawings.

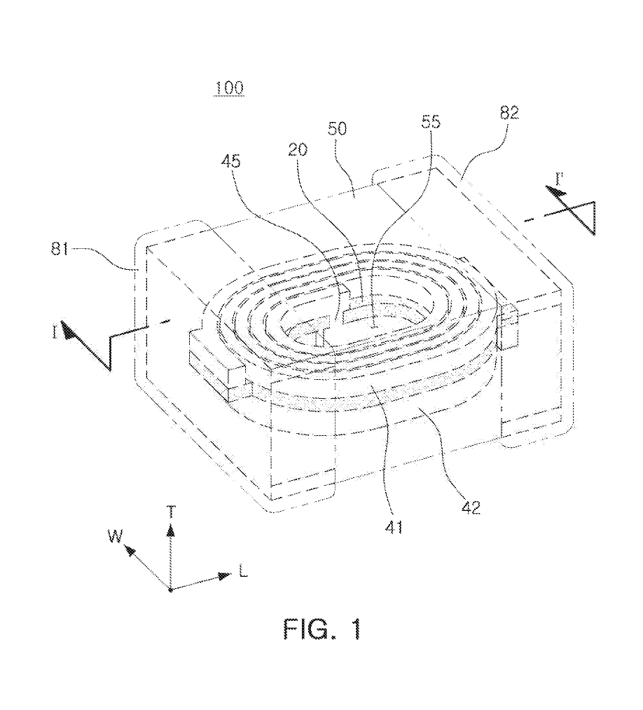

FIG. 1 is a schematic perspective view of a coil component according to an exemplary embodiment in the present disclosure.

A coil component 100 according to an exemplary embodiment in the present disclosure may include a magnetic body 50, first and second coil parts 41 and 42 disposed in the magnetic body 50, and first and second external electrodes 81 and 82 disposed on outer surfaces of the magnetic body 50 and electrically connected to the first and second coil parts 41 and 42. In the coil component 100 according to an exemplary embodiment in the present disclosure, a ‘length direction’ refers to an ‘L’ direction of FIG. 1, a ‘width direction’ refers to a ‘W’ direction of FIG. 1, and a ‘thickness direction’ refers to a ‘T’ direction of FIG. 1.

The magnetic body 50 may form an outer shape of the coil component 100 and may be formed by filling a magnetic material in a substrate 20. As an example, the magnetic body 50 may be formed by filling a ferrite or a metallic magnetic powder in the substrate 20. The ferrite may be, for example, a Mn—Zn based ferrite, a Ni—Zn based ferrite, a Ni—Zn—Cu based ferrite, a Mn—Mg based ferrite, a Ba-based ferrite, a Li-based ferrite, or the like. The metallic magnetic powder may include any one or more selected from a group consisting of iron (Fe), silicon (Si), chromium (Cr), aluminum (Al), and nickel (Ni). For example, the metallic magnetic powder may be a Fe—Si—B—Cr based amorphous metal, but is not limited thereto. The metallic magnetic powder may have a particle diameter of 0.1 μm to 30 μm, and may be contained in a form in which it is dispersed in an epoxy resin or a thermosetting resin such as polyimide or the like.

The substrate 20 may be disposed in the magnetic body 50. As an example, the substrate 20 may include an epoxy based insulating substrate, a ferrite substrate, or a metallic based soft magnetic substrate.

The first coil part 41 having a coil shape may be formed on one surface of the substrate 20, and the second coil part 42 having the coil shape may be formed on the other surface of the substrate 20 opposite to one surface of the substrate 20. The first and second coil parts 41 and 42 may be formed by an electroplating process.

A central portion of the substrate 20 may be penetrated to form a hole, and the hole may be filled with a magnetic material to form a core part 55. As the core part 55 filled with the magnetic material is formed, an inductance Ls may be improved.

The first and second coil parts 41 and 42 may have a spiral shape, and the first and second coil parts 41 and 42 formed on one surface and the other surface of the substrate 20 may be electrically connected to each other through a via 45 penetrating through the substrate 20.

The first and second coil parts 41 and 42 and the via 45 may be formed of a metal having excellent electrical conductivity, and may be formed of, for example, silver (Ag), palladium (Pd), aluminum (Al), nickel (Ni), titanium (Ti), gold (Au), copper (Cu), platinum (Pt), or an alloy thereof.

A direct current (DC) resistance Rdc, which is one of main characteristics of the inductor, may be decreased as cross-sectional areas of the coil parts are increased. In addition, an inductance of the inductor may be increased as an area of the magnetic body through which magnetic flux passes may be increased. Therefore, in order to decrease the DC resistance Rdc and improve the inductance, it is necessary to increase the cross-sectional areas of the coil parts and to increase the area of the magnetic body.

In order to increase the cross-sectional areas of the coil parts, a method of increasing a line width of the coil and a method of increasing a thickness of the coil may be used. However, in the case in which the line width of the coil is increased, there is a great possibility that a short between adjacent coils is generated, and there is a limit in the number of coil turns that can be implemented, leading to reduction in the area of the magnetic body, resulting in lowered efficiency and limitation in implementation of a high-capacity product. Therefore, a coil part of a structure having a high aspect ratio (AR) is required by increasing the thickness of the coil relative to the line width of the coil.

An aspect ratio (AR) of the coil parts means a value obtained by dividing the thickness of the coil by the line width of the coil. As an increased amount of the thickness of the coil is greater than an increased amount of the line width of the coil, a high aspect ratio (AR) may be implemented. However, in a case in which the coil parts are formed by performing a pattern plating method, in order to form the coil with a large thickness, it is necessary to increase the thickness of an insulating partition for insulating adjacent coils. However, as the thickness of the insulating partition is increased, there is a limit to an exposure process in which the exposure of a lower portion of the insulating partition is not smooth, and it is thus difficult to increase the thickness of the coil.

In addition, in order to maintain a form of the insulating partition having the increased thickness, the insulating partition needs to have a predetermined width or more. Since a width of the insulating partition after removing the insulating partition becomes an interval between the adjacent coils, the interval between the adjacent coils may be increased. As a result, there is a limit in improving the DC resistance Rdc and inductance Ls characteristics.

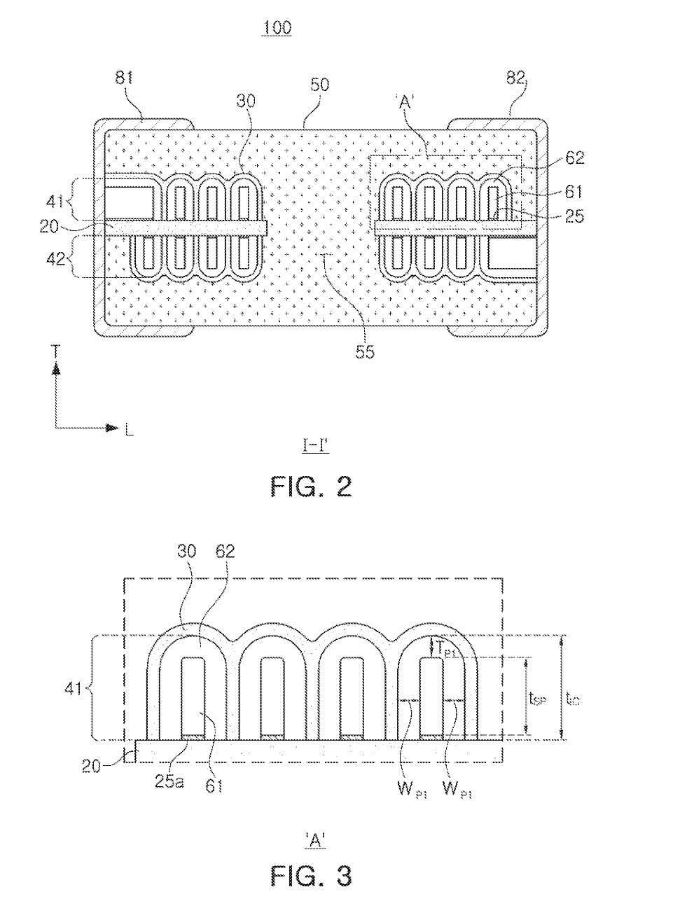

FIG. 2 is a cross-sectional view taken along a line I-I′ of the coil component according to the exemplary embodiment of FIG. 1.

Referring to FIG. 2, the first and second coil parts 41 and 42 may include a seed pattern 25 formed on the substrate 20, a first plating layer 61 extending upwardly or downwardly along a thickness direction of the magnetic body 50 from the seed pattern 25, and a second plating layer 62 covering the first plating layer 61.

The first and second coil parts 41 and 42 may be covered with an insulating layer 30. The insulating layer 30 may be formed by a screen printing method, an exposure and development method of a photoresist (PR), or a spray applying method. The first and second coil parts 41 and 42 may be covered with the insulating layer 30 so as not to in direct contact with the magnetic material forming the magnetic body 50.

One end portion of the first coil part 41 formed on one surface of the substrate 20 may be exposed to one end surface of the magnetic body 50 in the length L direction of the magnetic body 50, and one end portion of the second coil part 42 formed on the other surface of the substrate 20 may be exposed to the other end surface of the magnetic body 50 in the length L direction of the magnetic body 50. However, depending on the exemplary embodiments, one end portion of each of the first and second coil parts 41 and 42 may be exposed to the same end surface in the length L direction, or one end portion of each of the first and second coil parts 41 and 42 may be exposed to the same end surface in the length L direction, or one end portion and the other end portion of each of the first and second coil parts 41 and 42 may be exposed to the same one end surface and the other end surface in the length L direction. The first and second external electrodes 81 and 82 may be formed on the outer surfaces of the magnetic body 50 so as to be connected to each of the first and second coil parts 41 and 42 exposed to the end surfaces of the magnetic body 50.

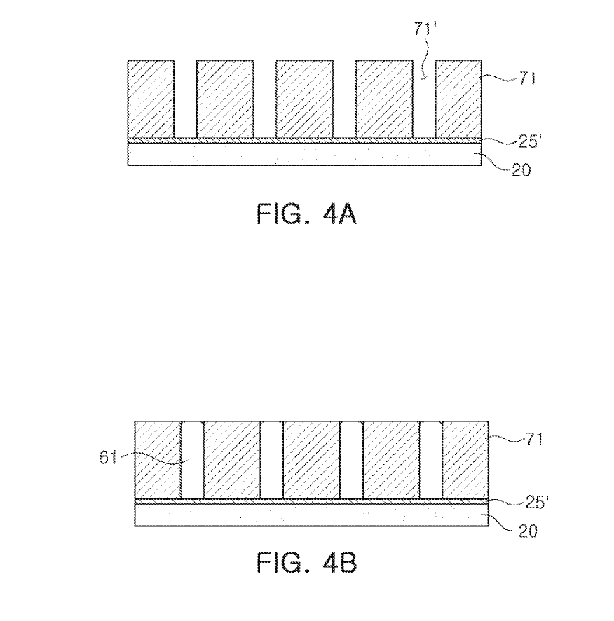

FIG. 3 illustrates an example of an enlarged view of a portion ‘A’ of the coil component according to the exemplary embodiment of FIG. 2.

Referring to FIGS. 2 and 3, the seed pattern 25 of FIG. 2 may include, for example, a first seed pattern 25a. As an example, the first seed pattern 25a may be formed of at least one of copper (Cu), titanium (Ti), nickel (Ni), tin (Sn), aluminum (Al), and molybdenum (Mo). The first seed pattern 25a may be disposed on a lower surface of the first plating layer 61. The first plating layer 61 may be formed by performing an electroplating process on the first seed pattern 25a by using the first seed pattern 25a as the seed layer. The first plating layer 61 may be formed by performing at least one electroplating process on the first seed pattern 25a. As an example, a line width of the first plating layer 61 may be equal to that of the first seed pattern 25a.

The second plating layer 62 covering the first plating layer 61 may be formed by performing the electroplating by using the first plating layer 61 as the seed layer. The cross-sectional areas of the coil parts may be further increased by forming the second plating layer 62 on the surface of the first plating layer 61, thereby improving DC resistance Rdc and inductance Ls characteristics. The second plating layer 62 according to an exemplary embodiment in the present disclosure illustrated in FIG. 3 shows a similar shape in related to a width direction growth degree W_{P1} and a thickness direction growth degree T_{P1}. As described above, the second plating layer 62 formed on the first plating layer 61 is formed as an isotropic plating layer in which the width direction growth degree W_{P1} and the thickness direction growth degree T_{P1} are similar to each other, such that a thickness difference between the adjacent coils may be reduced to allow for the coils to have a uniform thickness, thereby reducing the scattering of the DC resistance Rdc. In addition, the second plating layer 62 may be formed as the isotropic plating layer to straightly form the first and second coil parts 41 and 42 without being bent, such that a short between the adjacent coils may be prevented and a defect that the insulating layer 30 is not formed on a portion of the first and second coil parts 41 and 42 may be prevented.

At this time, a thickness t_{SP} of the first plating layer 61 may be 50% or more of a total thickness t_{IC} of the first and second coil parts 41 and 42 including the first seed pattern 25a, the first plating layer 61, and the second plating layer 62. The total thickness t_{IC} of the first and second coil parts 41 and 42 according to an exemplary embodiment in the present disclosure formed as described above may be 150 μm or more, and an aspect ratio (AR) thereof may be 2.0 or more.

The insulating layer 30 may be formed on the second insulating layer 62. The insulating layer 30 may be formed on the surface of the second plating layer 62 by a screen printing method, an exposure and development method of a photoresist (PR), or a spray applying method.

Meanwhile, surface roughness Ra of the second plating layer 62 may be 1 nm to 600 nm. The surface roughness of 1 nm to 600 nm may be applied to the surface of the second plating layer 62 by etching or oxidizing the surface of the second plating layer 62.

According to an exemplary embodiment in the present disclosure, the surface roughness of 1 nm to 600 nm is applied to the surface of the second plating layer 62, such that adhesion between the second plating layer 62 and the insulating layer 30 formed on the surface of the second plating layer 62 may be increased.

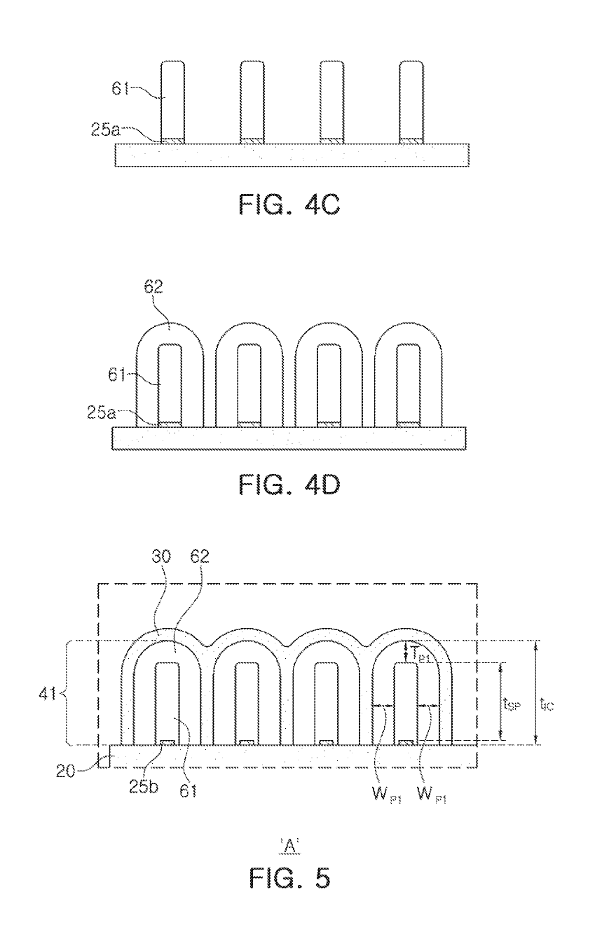

FIGS. 4A through 4d are views illustrating processes of manufacturing the coil component according to the exemplary embodiment of FIG. 3.

Referring to FIG. 4A, an insulating partition 71 having a plurality of openings 71′ may be formed on a substrate 20 on which a thin film conductive layer 25′ is entirely formed. As an example, the insulating partition 71 may have a thickness of 40 μm to 60 μm. The thin film conductive layer 25′ may be formed by a sputtering process, an electroless plating process, or a chemical vapor deposition (CVD) process. The insulating partition 71 having the plurality of openings 71′ may be formed by applying an insulator on the thin film conductive layer 25′ and then applying an exposure and development process to some regions. The insulator may include an epoxy based compound and may include a photosensitive material containing a bisphenol-based epoxy resin as a main component, for example, a permanent type photosensitive insulating material.

Referring to FIG. 4B, the first plating layer 61 may be formed in the openings 71′. As an example, the first plating layer 61 may be formed by a plating process using the thin film conductive layer 25′ as a seed layer. According to an exemplary embodiment in the present disclosure, the thin film conductive layer 25′ used as the seed layer is formed on a front surface of the substrate 20, such that the insulating partition 71 and the first plating layer 61 may be easily aligned.

Meanwhile, as a result of the plating process of FIG. 4B, when an upper surface of the first plating layer 61 is positioned higher than an upper surface of the insulating partition 71, a polishing process may be performed to prevent a short between adjacent first plating layers 61. As the polishing process, mechanical polishing or chemical polishing may be applied. Unlike this, when the upper surface of the first plating layer 61 is positioned lower than the upper surface of the insulating partition and under plating is performed, the polishing process may be omitted.

Referring to FIG. 4C, the insulating partition 71 and the thin film conductive layer 25′ out of regions on which the first plating layer 61 is formed are removed, so that the first seed pattern 25a may be formed only on the lower surface of the first plating layer 61. As an example, the insulating partition 71 and the thin film conductive layer 25′ out of regions on which the first plating layer 61 is formed may be removed by a laser trimming process.

Referring to FIG. 4D, the second plating layer 62 may be formed on the first plating layer 61. As an example, the second plating layer 61 may be formed by a plating process using the first plating layer 61 as a seed layer.

Meanwhile, surface roughness Ra may be then applied to a surface of the second plating layer 62. As an example, the surface roughness Ra may be 1 nm to 600 nm. The surface roughness of 1 nm to 600 nm may be applied to the surface of the second plating layer 62 by etching or oxidizing the surface of the second plating layer 62.

According to an exemplary embodiment in the present disclosure, the surface roughness of 1 nm to 600 nm is applied to the surface of the second plating layer 62, such that adhesion between the second plating layer 62 and the insulating layer 30 formed on the surface of the second plating layer 62 may be increased.

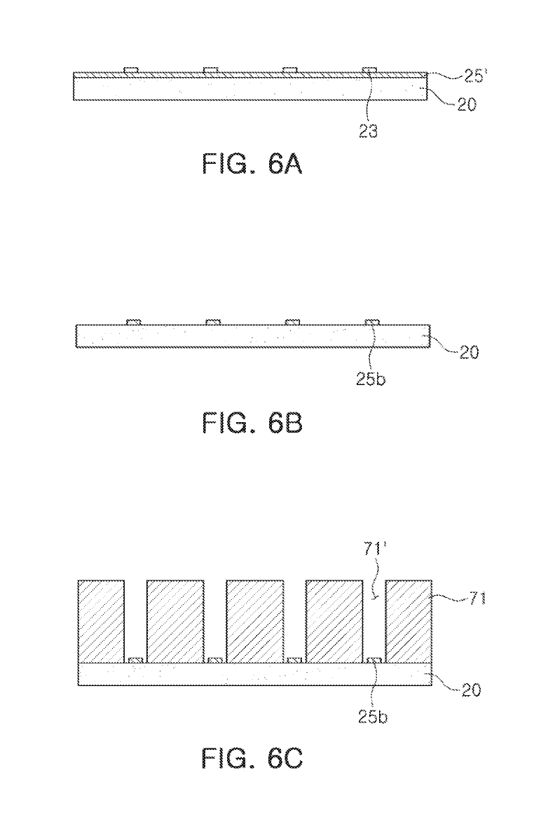

FIG. 5 illustrates another example of the enlarged view of the portion ‘A’ of the coil component according to the exemplary embodiment of FIG. 2. Since an exemplary embodiment of FIG. 5 is similar to the exemplary embodiment of FIG. 3, an overlapped description is omitted and only a difference will be described.

Referring to FIGS. 2 and 5, the seed pattern 25 of FIG. 2 may include, for example, second seed pattern 25b. As an example, the second seed pattern 25b may be formed of copper (Cu). The second seed pattern 25b may be disposed on the lower surface of the first plating layer 61. The first plating layer 61 may be formed by performing electroplating on the second seed pattern 25b by using the second seed pattern 25b as the seed layer. As an example, a line width of the first plating layer 61 may be greater than that of the second seed pattern 25b. The second plating layer 62 formed on the first plating layer 61 may be formed by performing the electroplating process using the first plating layer 61 as the seed layer. The insulating layer 30 may be formed on the second insulating layer 62. The insulating layer 30 may be formed on the surface of the second plating layer 62 by a screen printing method, an exposure and development method of a photoresist (PR), or a spray applying method.

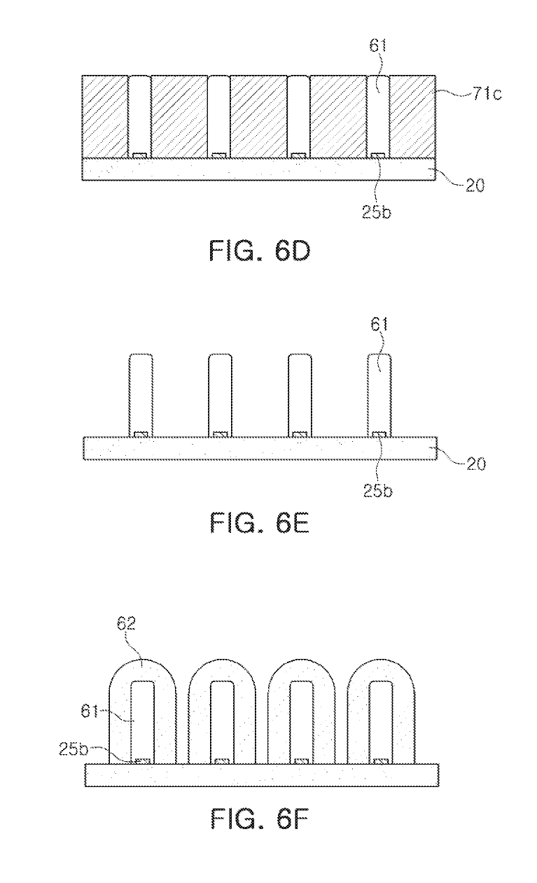

FIGS. 6A through 6F are views illustrating processes of manufacturing the coil component according to the exemplary embodiment of FIG. 5.

Referring to FIG. 6A, a photoresist 23 having a plurality of opening patterns may be formed on the substrate 20 on which the thin film conductive layer 25′ is entirely formed. The thin film conductive layer 25′ may be formed by a sputtering process, an electroless plating process, or a chemical vapor deposition (CVD) process.

Referring to FIG. 6B, the second seed patterns 25b may be formed by etching the thin film conductive layer 25′ exposed by the opening pattern of the photoresist 23 and delaminating the photoresist 23.

Referring to FIG. 6C, the insulating partition 71 may be formed on a region out of a region on which the second seed pattern 25b is formed. The insulating partition 71 having the plurality of openings 71′ may be formed by applying an insulator on the thin film conductive layer 25′ and then applying an exposure and development process to some regions. The insulator may include an epoxy based compound and may include a photosensitive material containing a bisphenol-based epoxy resin as a main component, for example, a permanent type photosensitive insulating material.

Referring to FIG. 6D, the first plating layer 61 may be formed in the opening 71′. As an example, the first plating layer 61 may be formed by a plating process using the second seed pattern 25b as a seed layer.

Meanwhile, as a result of the plating process of FIG. 6D, when an upper surface of the first plating layer 61 is positioned higher than an upper surface of the insulating partition 71, a polishing process may be performed to prevent a short between adjacent first plating layers 61. As the polishing process, mechanical polishing or chemical polishing may be applied. Unlike this, when the upper surface of the first plating layer 61 is positioned lower than the upper surface of the insulating partition and under plating is performed, the polishing process may be omitted.

Referring to FIG. 6E, the insulating partition 71 is removed, and the first plating layer 61 and the second seed pattern 25b may remain so that the seed pattern 25b having a line width smaller than that of the first plating layer 61 is disposed on the lower surface of the first plating layer 61. As an example, the insulating partition 71 may be removed by a laser trimming process.

Referring to FIG. 6F, the second plating layer 62 may be formed on the first plating layer 61. As an example, the second plating layer 61 may be formed by a plating process using the first plating layer 61 as a seed layer.

Meanwhile, surface roughness Ra may be then applied to a surface of the second plating layer 62. As an example, the surface roughness Ra may be 1 nm to 600 nm. The surface roughness of 1 nm to 600 nm may be applied to the surface of the second plating layer 62 by etching or oxidizing the surface of the second plating layer 62.

According to an exemplary embodiment in the present disclosure, the surface roughness of 1 nm to 600 nm is applied to the surface of the second plating layer 62, such that adhesion between the second plating layer 62 and the insulating layer 30 formed on the surface of the second plating layer 62 may be increased.

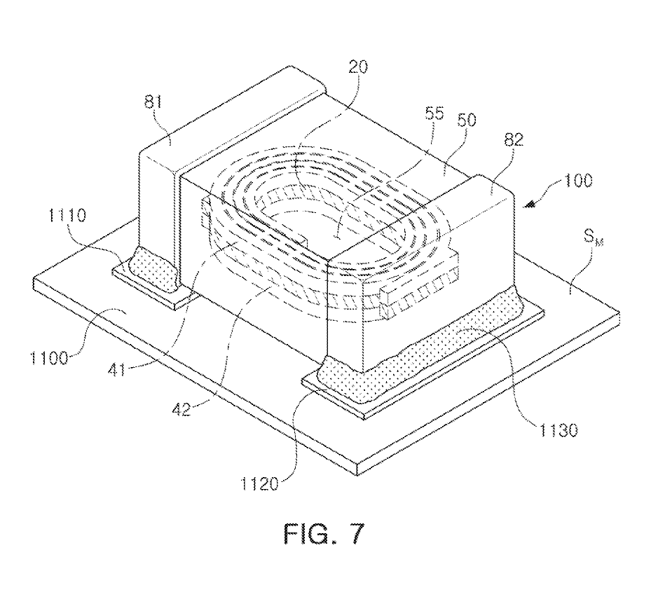

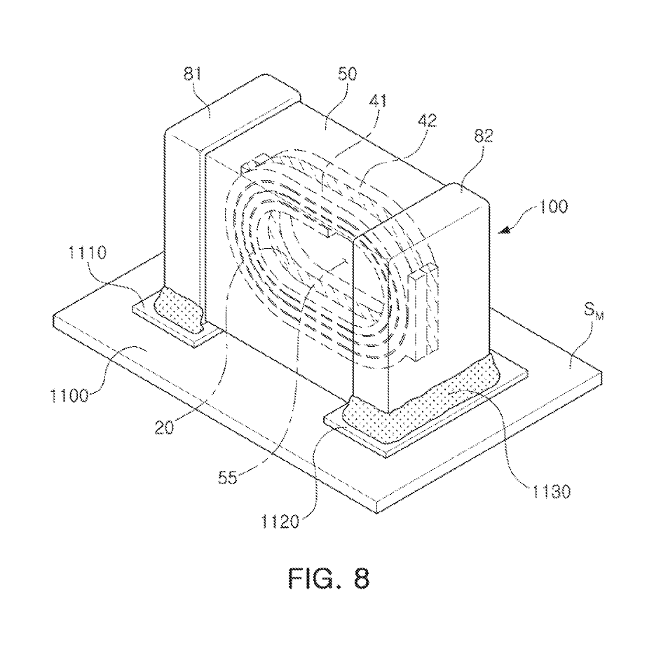

FIGS. 7 and 8 are perspective views illustrating figures in which the coil component according to an exemplary embodiment in the present disclosure is mounted on a printed circuit board.

A printed circuit board 1000 according to an exemplary embodiment in the present disclosure may include first and second electrode pads 1110 and 1120 which are spaced apart from each other. The first and second external electrodes 81 and 82 formed on both end surfaces of the coil component 100 may be disposed on the first and second electrode pads 1110 and 1120, respectively, and may be electrically connected to the printed circuit board 1100 by a solder 1130.

At this time, referring to FIG. 7, the first and second coil parts 41 and 42 of the coil component 100 may be disposed to be parallel with respect to amounting surface of the printed circuit board 1100. Referring to FIG. 8, the first and second coil parts 41 and 42 of the coil component 100 may be disposed to be perpendicular to the mounting surface of the printed circuit board 1100.

As set forth above, according to an exemplary embodiment in the present disclosure, the cross-sectional areas of the coil parts may be increased, and the DC resistance Rdc characteristics may be improved. According to an exemplary embodiment in the present disclosure, roughness is applied to the surfaces of the coil parts, such that adhesion between the coil parts and insulating layers formed on the surfaces of the coil parts may be increased.

While exemplary embodiments have been shown and described above, it will be apparent to those skilled in the art that modifications and variations could be made without departing from the scope of the present invention as defined by the appended claims.

What is claimed is:

1. A coil component comprising:
a magnetic body including a magnetic material; and
a coil part disposed in the magnetic body,
wherein the coil part includes a first plating layer and a second plating layer disposed on a surface of the first plating layer, and
a surface roughness of the second plating layer is within a range from 1 nm to 600 nm.

2. The coil component of claim 1, further comprising an insulating layer formed on the second plating layer.

3. The coil component of claim 1, wherein the first plating layer has a total thickness of 100 μm or more.

4. The coil component of claim 1, wherein a thickness of the first plating layer is equal to 50% or more of a total thickness of the coil part.

5. The coil component of claim 1, wherein the first plating layer is grown in a thickness direction of the magnetic body.

6. The coil component of claim 1, wherein the second plating layer covers the first plating layer.

7. The coil component of claim 1, wherein the second plating layer is grown isotropically on the first plating layer.

8. The coil component of claim 1, wherein the coil part further includes a seed pattern disposed on a lower surface of the first plating layer.

9. The coil component of claim 8, wherein a line width of the first plating layer is equal to that of the seed pattern.

10. The coil component of claim 8, wherein a line width of the first plating layer is greater than that of the seed pattern.

11. A printed circuit board including the coil component of claim 1, wherein the coil part is disposed to be parallel to a surface of the printed circuit board.

12. A printed circuit board including the coil component of claim 1, wherein the coil part is disposed to be perpendicular to a surface of the printed circuit board.

13. A method of manufacturing a coil component, the method comprising steps of:
forming a coil part on a substrate; and
forming a magnetic body by filling magnetic material in the substrate on which the coil part is formed,
wherein the forming of the coil part includes:
forming a seed pattern on the substrate,
plating a first plating layer on the seed pattern,
plating a second plating layer on the first plating layer, and
applying surface roughness to the second plating layer.

14. The method of claim 13, wherein the surface roughness is within a range from 1 nm to 600 nm.

15. The method of claim 13, wherein the surface roughness is formed by etching a surface of the second plating layer.

16. The method of claim 13, wherein the surface roughness is formed by oxidizing a surface of the second plating layer.

17. The method of claim 13, wherein the first plating layer is grown in a thickness direction of the magnetic body.

18. The method of claim 13, wherein the second plating layer is grown isotropically on the first plating layer.

19. The method of claim 13, further comprising a step of forming an insulating partition on the substrate prior to plating the first plating layer on the seed pattern,
wherein the insulating partition is removed prior to the step of plating the second plating layer on the first plating layer.

20. The method of claim 19, further comprising a step of etching the seed pattern prior to the step of forming the insulating partition.

21. The method of claim 19, wherein, after the step of plating the first plating layer on the seed pattern, an upper surface of the first plating layer is higher than an upper surface of the insulating partition.
